(19) United States
(12) Patent Application Publication
(10) Pub. No.: US 2022/0386374 A1
(43) Pub. Date: Dec. 1, 2022

(54) WIRELESS LAN SYSTEM, ACCESS POINT DEVICE, AND WIRELESS COMMUNICATION METHOD

(71) Applicant: NIPPON TELEGRAPH AND TELEPHONE CORPORATION, Tokyo (JP)

(72) Inventors: Kenichi KAWAMURA, Musashino-shi, Tokyo (JP); Yasushi TAKATORI, Musashino-shi, Tokyo (JP); Takatsune MORIYAMA, Musashino-shi, Tokyo (JP); Shota NAKAYAMA, Musashino-shi, Tokyo (JP); Keisuke WAKAO, Musashino-shi, Tokyo (JP)

(73) Assignee: NIPPON TELEGRAPH AND TELEPHONE CORPORATION, Tokyo (JP)

(21) Appl. No.: 17/772,072

(22) PCT Filed: Nov. 13, 2019
(86) PCT No.: PCT/JP2019/044562

§ 371 Date: Apr. 26, 2022

(51) Int. Cl. H04W 74/08; H04W 72/04

(52) U.S. Cl. CPC H04W 74/0816; H04W 72/0446; H04W 84/12

(57) ABSTRACT

In a wireless LAN system that performs multi-user transmission, an access point device includes: a selection unit configured to select, as terminals to be caused to transmit CTS in response to an MU-RTS frame, terminals that satisfy predetermined conditions and include at least a terminal that is to be protected and has to satisfy predetermined low latency and low jitter, regardless of whether or not the terminals are terminals to which a resource for transmitting data should be allocated; an allocation unit configured to allocate the resource for transmitting data to the terminals; a frame generation unit configured to generate the MU-RTS frame such that the terminals selected by the selection unit transmit the CTS, and generates a frame that contains a signal indicating the resource allocated by the allocation unit; and a communication unit configured to transmit the frames generated by the frame generation unit to the plurality of terminals. The selection unit selects terminals the number of which is greater than or equal to the number of terminals to which the resource is allocated by the allocation unit.

### TECHNICAL FIELD

The present invention relates to a wireless LAN system, an access point device, and a wireless communication method.

### BACKGROUND ART

Wireless LANs are widely used as a wireless access means, due to their large bandwidth and the convenience of being easily installable by anyone, for example. Representative frequency bands used by wireless LANs are the 2.4 GHz band and the 5 GHz band, for which no license is required. Therefore, anyone can install a wireless device (transmitter/receiver) without applying for a license, and can use a wireless LAN.

Specifications (see NPL 1) for wireless LANs are laid down by the IEEE, and CSMA/CA (Carrier Sense Multiple Access/Collision Avoidance) is used as a wireless access method. CSMA/CA is a method in which each terminal (STA: station, terminal station, slave device) performs a carrier sense before transmission, and then starts transmission when it is confirmed that a channel is not being used for a certain period of time.

If a channel is being used, each terminal in a wireless LAN waits until the use of the channel ends, and then waits for transmission for predetermined time and the randomly selected number of slots, and if the channel is not used during this period of time, the terminal transmits a wireless frame. In this way, a plurality of terminals in a wireless LAN performs wireless communication while autonomously avoiding collisions with each other.

However, in the CSMA/CA method, due to the effects of the distance between terminals, an obstacle that blocks radio waves, and the like, a transmitter sometimes cannot sense the condition of radio waves in the surroundings of a receiver during a carrier sense. For example, if a wireless frame that may affect the receiver is transmitted from a wireless device located at a position at which it cannot receive radio waves from the transmitter, a wireless frame transmitted from the transmitter to the receiver collides on the receiver side and results in a reception error. Such a problem is referred to as a hidden node problem.

In order to avoid the hidden node problem, an RTS (Request to send)/CTS (Clear to send) procedure is implemented for wireless LANs as a standard technique. In the RTS/CTS procedure, first, a transmitter transmits a signal called RTS before transmitting a data frame. Upon receiving the RTS, a receiver transmits CTS. After confirmation of the completion of the RTS/CTS exchange, the transmitter transmits the actual data frame.

RTS and CTS frames contain, in a duration field, time required to transmit a data frame scheduled to be transmitted. A terminal that has received the broadcast RTS/CTS waits for transmission for the time written in the duration field.

In wireless LANs, such waiting for transmission is referred to as a NAV (Network Allocation Vector), in which media are set to be busy by a virtual carrier sense. That is to say, by performing an RTS/CTS procedure before transmitting a data frame, a wireless LAN prevents transmission from surrounding wireless devices, and reduces interference.

Furthermore, additional functions of wireless LAN standards are continuously specified. The IEEE802.11ax standard (see NPL 2) employs multi-user transmission with MU-MIMO (Multi User MIMO) and OFDMA (Orthogonal frequency-division multiple access).

In conventional wireless LANs, the transmission of a wireless frame is one-to-one communication (single-user transmission). In contrast, in multi-user transmission, an access point device (AP device, AP, station, master device) can communicate with a plurality of terminals (STA) at the same time, and efficient use of wireless resources (hereinafter, referred to simply as “resources”) is attempted.

In OFDMA, it is possible to allocate resources to a plurality of terminals in terms of subcarriers, and the access point device can perform transmission to the plurality of terminals at the same time, or can perform reception from the plurality of terminals at the same time. The minimum unit of resources to be allocated in OFDMA is referred to as a resource unit (RU).

Also, in multi-user transmission using OFDMA, an MU-RTS (Multi User RTS)/CTS procedure, which is an extension of a conventional RTS/CTS procedure, can be performed before a data frame is transmitted/received.

In the MU-RTS/CTS procedure, first, an access point device transmits MU-RTS in which a plurality of terminals with which the access point device is scheduled to communicate are set as destinations. Upon receiving the MU-RTS, a terminal transmits CTS after a predetermined waiting period of time, if the terminal is set as a destination in the MU-RTS.

CTS is transmitted from the plurality of terminals, but is transmitted at a timing at which they are synchronized in the order of μ seconds as defined by the MU-RTS, and thus mutual interference is avoided.

### CITATION LIST

### Non Patent Literature

[NPL 1] IEEE Std 802.11-2016, IEEE Standard for Information technology—Telecommunications and information exchange between systems Local and metropolitan area networks—Specific requirements, Part 11: Wireless LAN Medium Access Control (MAC) and Physical Layer (PHY) Specifications, Revision of IEEE Std 802.11-2012, p. 1295-1580
[NPL 2] IEEE P802.11ax/D4.0 Draft Standard for Information technology—Telecommunications and information exchange between systems Local and metropolitan area networks—Specific requirements, Part 11: Wireless LAN Medium Access Control (MAC) and Physical Layer (PHY) Specifications, Amendment 1: Enhancements for High Efficiency WLAN, February 2019, p. 69-272, p. 295-440

### SUMMARY OF THE INVENTION

### Technical Problem

Conventional wireless LAN systems have the problem that although a reliable quality can be guaranteed in an environment in which there are a small number of terminals and there is less interference from the surroundings, increases in the number of terminals and in interference from the surroundings lead to frame collisions or frequent occurrence of waiting for transmission, resulting in a deterioration in the communication quality. Specifically, in applications such as VoIP (Voice over IP) and streaming videos that require real-time characteristics, the communication quality of a wireless LAN is essential.

Accordingly, a QoS (Quality of Service) technology is employed also in wireless LAN standards (see NPL 1). For example, a quality improvement technology using admission control of changing waiting time at the time of a carrier sense for every priority, or centralized polling control is standardized, and part of the technology is actually widely used.

However, if such control is performed using a network of devices in a factory and the like, or if a VR (Virtual Reality) application or the like is used, there are cases where communication with lower-latency and lower-jitter than before is required. In order to satisfy these requirements in wireless communication, a quality higher than that of the conventional techniques needs to be guaranteed.

Specifically, frequency bands of wireless LANs do not require any license, and anyone can install a wireless device without applying for a license, and thus suppressing interference from the surroundings is needed to realize reliable communication.

For example, in conventional wireless LAN systems, if a terminal belonging to a predetermined BSS (Basic Service Set) receives interference from a surrounding OBSS (Overlapping BSS) of the same channel, a delay or a jitter is not secured, and an application that requires low-latency and low-jitter cannot be provided.

Specifically, even if RTS/CTS or MU-RTS/CTS is used, there is also a possibility that out of a coverage of a signal transmitted from a terminal, there is another wireless LAN device such as an access point device. In this case, protection using RTS/CTS or MU-RTS/CTS cannot work well, and the other wireless LAN such as an access point device may function as a source of interference with the terminal.

An object of the present invention is to provide a wireless LAN system, an access point device, and a wireless communication method that can protect a communication opportunity for a predetermined terminal, and can improve the communication quality.

### Means for Solving the Problem

According to an aspect of the present invention, a wireless LAN system that performs multi-user transmission using OFDMA between a plurality of terminals and at least one access point device, wherein the access point device includes: a selection unit configured to select, as terminals to be caused to transmit CTS in response to an MU-RTS frame, terminals that satisfy predetermined conditions and include at least a terminal that is to be protected and has to satisfy predetermined low latency and low jitter, regardless of whether or not the terminals are terminals to which a resource for transmitting data should be allocated; an allocation unit configured to allocate the resource for transmitting data to the terminals; a frame generation unit configured to generate the MU-RTS frame such that the terminals selected by the selection unit transmit the CTS, and generates a frame that contains a signal indicating the resource allocated by the allocation unit; and a communication unit configured to transmit the frames generated by the frame generation unit to the plurality of terminals, and the selection unit selects terminals the number of which is greater than or equal to the number of terminals to which the resource is allocated by the allocation unit.

Also, according to an aspect of the present invention, an access point device that performs multi-user transmission using OFDMA to a plurality of terminals, the access point device comprising: a selection unit configured to select, as terminals to be caused to transmit CTS in response to an MU-RTS frame, terminals that satisfy predetermined conditions and include at least a terminal that is to be protected and has to satisfy predetermined low latency and low jitter, regardless of whether or not the terminals are terminals to which a resource for transmitting data should be allocated; an allocation unit configured to allocate the resource for transmitting data to the terminals; a frame generation unit configured to generate the MU-RTS frame such that the terminals selected by the selection unit transmit the CTS, and generates a frame that contains a signal indicating the resource allocated by the allocation unit; and a communication unit configured to transmit the frames generated by the frame generation unit to the plurality of terminals, wherein the selection unit selects terminals the number of which is greater than or equal to the number of terminals to which the resource is allocated by the allocation unit.

Furthermore, according to an aspect of the present invention, a wireless communication method for performing multi-user transmission using OFDMA between a plurality of terminals and at least one access point device, the method comprising: a selection step of selecting, as terminals to be caused to transmit CTS in response to an MU-RTS frame, as terminals to be caused to transmit CTS in response to an MU-RTS frame, terminals that satisfy predetermined conditions and include at least a terminal that is to be protected and has to satisfy predetermined low latency and low jitter, regardless of whether or not the terminals are terminals to which a resource for transmitting data should be allocated; an allocation step of allocating the resource for transmitting data to the terminals; a frame generation step of generating the MU-RTS frame such that the selected terminals transmit the CTS, and generates a frame that contains a signal indicating the allocated resource; and a communication step of transmitting the generated frames to the plurality of terminals, wherein in the selection step, terminals the number of which is greater than or equal to the number of terminals to which the resource is allocated in the allocation step are selected.

### Effects of the Invention

According to the present invention, it is possible to protect a communication opportunity for a predetermined terminal, and can improve the communication quality.

### BRIEF DESCRIPTION OF DRAWINGS

FIG. 1 is a diagram illustrating an example of a configuration of a wireless LAN system according to an embodiment.

FIG. 2 is a diagram illustrating an example of a configuration of an access point device according to the embodiment.

FIG. 3 is a diagram illustrating a configuration of a trigger frame that is transmitted by the access point device.

FIG. 4 is a diagram illustrating an example of a configuration of a terminal.

FIG. 5 is a diagram schematically illustrating coverages of radio waves in a wireless LAN system of a comparative example.

FIG. 6 is a timing chart illustrating an example of a timing of data transmission in the wireless LAN system of the comparative example.

FIG. 7 is a diagram schematically illustrating coverages of radio waves in the wireless LAN system according to the embodiment.

FIG. 8 is a timing chart illustrating an example of a timing of data transmission in the wireless LAN system according to the embodiment.

FIG. 9 is a flowchart illustrating an example of an operation of the access point device according to the embodiment.

### DESCRIPTION OF EMBODIMENTS

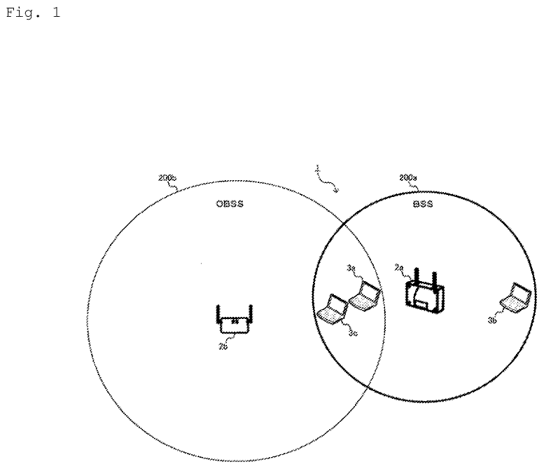

Hereinafter, an embodiment of a wireless LAN system will be described with reference to the drawings. FIG. 1 is a diagram illustrating an example of a configuration of a wireless LAN system 1 according to the embodiment. As shown in FIG. 1, the wireless LAN system 1 includes, for example, access point devices (AP devices) 2a and 2b, and terminals 3a, 3b, and 3c, and performs multi-user transmission with MU-MIMO and OFDMA, conforming to the IEEE802.11ax.

The access point device 2a emits radio waves such as MU-RTS of a predetermined level within a coverage 200a. The access point device 2b emits radio waves such as MU-RTS of a predetermined level within a coverage 200b.

The terminals 3a, 3b, and 3c belong to the access point device 2a. Here, it is assumed that the terminal 3a is a terminal (protected terminal) that is to be protected and has to satisfy predetermined conditions such as low latency, low jitter, and reduced packet loss. However, the terminal 3a may compete with the terminals 3b and 3c, which belong to a BSS with the access point device 2a set as an AP (access point), in terms of wireless access.

In addition to the BSS with the access point device 2a set as an AP, there is also an OBSS with the access point device 2b set as an AP. It is assumed that the terminals 3a and 3c are also able to recognize traffic from the access point device 2b. Hereinafter, if any one of a plurality of configurations such as the terminals 3a, 3b, and 3c is not specified, such a configuration is abbreviated simply as a terminal 3, for example.

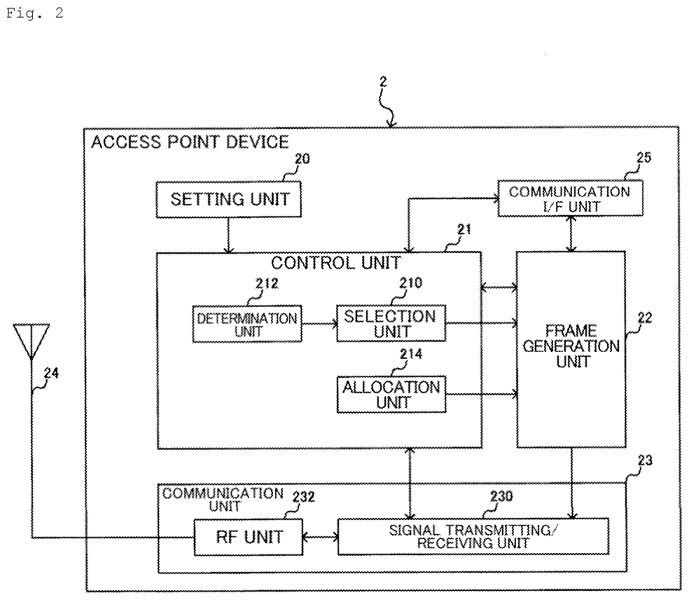

FIG. 2 is a diagram illustrating an example of a configuration of the access point device 2 according to the embodiment. As shown in FIG. 2, the access point device 2 includes, for example, a setting unit 20, a control unit 21, a frame generation unit 22, a communication unit 23, an antenna 24, and a communication interface (I/F) unit 25.

The setting unit 20 sets the control unit 21 to configure settings for operations of the access point device 2.

The control unit 21 includes the selection unit 210, a determination unit 212, and an allocation unit 214, and controls the components constituting the access point device 2.

The selection unit 210 selects (designates), as terminals to be caused to transmit CTS in response to an MU-RTS frame, terminals that satisfy predetermined conditions and include at least the above-described protected terminal (here, the terminal 3a), regardless of whether they are terminals to which resources for transmitting data should be allocated.

The determination unit 212 determines whether or not each of the terminals 3 is a terminal that should be caused to transmit CTS, based on the settings configured by the setting unit 20, and outputs the determination results to the selection unit 210. In this case, the selection unit 210 does not select a terminal 3 that has not been determined as the terminal that should be caused to transmit CTS by the determination unit 212, regardless of whether or not the terminal satisfies the predetermined conditions.

The allocation unit 214 allocates resources for transmitting data to the terminals (terminal designation), based on a trigger frame that is transmitted by the access point device 2 for example.

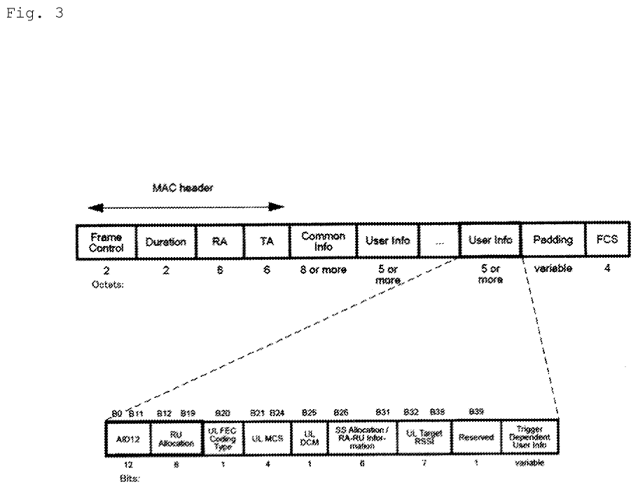

FIG. 3 is a diagram illustrating a configuration of a trigger frame that is transmitted by the access point device 2. In a User Info field of the trigger frame, the address of a terminal 3 to which a resource is to be allocated, and an RU to be allocated to the terminal 3 are described.

More specifically, based on information contained in AID and RU Allocation in a User Info field, a bandwidth of a channel through which CTS is to be transmitted is designated for the terminal 3. Also, a trigger frame format is used for MU-RTS.

Note that the selection unit 210 (FIG. 2) selects terminals the number of which is greater than or equal to the number of terminals to which the resources are allocated by the allocation unit 214. For example, the selection unit 210 selects, as terminals that satisfy one of predetermined conditions, terminals specified (set) in advance, terminals randomly specified from a plurality of terminals belonging to the access point device 2, terminals specified in the ascending order in the level of RSSI (Received Signal Strength Indicator) of the access point device 2, or terminals specified in the descending order in the amount of interference from the OBSS. The access point device 2 is notified of the amount of interference from the OBSS, for example, by the terminal 3.

The frame generation unit 22 generates an MU-RTS frame such that the terminals selected by the selection unit 210 transmit CTS, and generates a frame that contains signals indicating the resources allocated by the allocation unit 214, and outputs the generated frames to the communication unit 23.

The communication unit 23 includes a signal transmitting/receiving unit 230 and a RF (Radio Frequency) unit 232. The signal transmitting/receiving unit 230 executes processing for transmitting/receiving a signal with wireless, using the frames input from the frame generation unit 22. The RF unit 232 transmits/receives wireless frames in accordance with the processing of the signal transmitting/receiving unit 230 via the antenna 24. That is to say, the communication unit 23 has a function of transmitting the frames generated by the frame generation unit 22 to a plurality of terminals, and receiving frames transmitted by the plurality of terminals.

The communication I/F unit 25 performs interface processing in communication with another device.

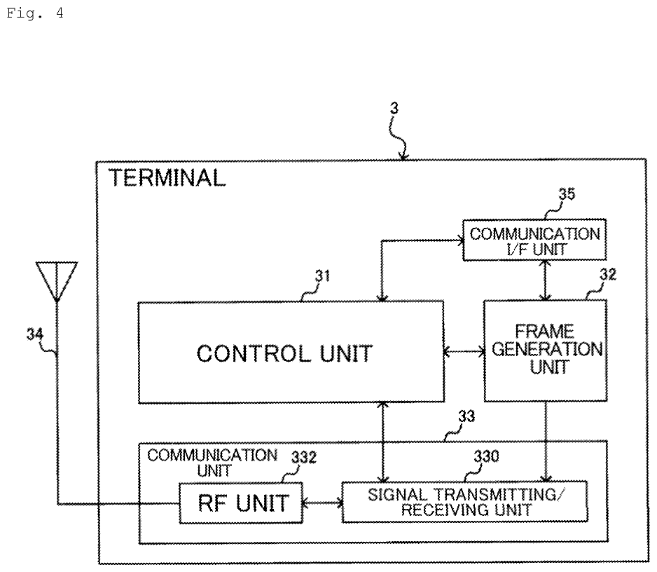

FIG. 4 is a diagram illustrating an example of a configuration of the terminal 3. As shown in FIG. 4, the terminal 3 includes, for example, a control unit 31, a frame generation unit 32, a communication unit 33, an antenna 34, and a communication interface (I/F) unit 35.

The control unit 31 controls the components constituting this terminal 3. The frame generation unit 32 generates frames of a transmission signal, and outputs the generated frames to the communication unit 33.

The communication unit 33 includes a signal transmitting/receiving unit 330 and a RF (Radio Frequency) unit 332. The signal transmitting/receiving unit 330 executes processing for transmitting/receiving a signal with wireless frames, using the frames input from the frame generation unit 32. The RF unit 332 transmits/receives wireless frames via the antenna 34 in accordance with the processing of the signal transmitting/receiving unit 330. That is to say, the communication unit 33 has a function of transmitting the frames generated by the frame generation unit 32, and receiving frames transmitted by the access point device 2 or another terminal.

The communication I/F unit 35 performs interface processing in communication with another device.

The following will more specifically describe an operation of the wireless LAN system 1 according to the embodiment, based on a comparison with an operation of a wireless LAN system of a comparative example.

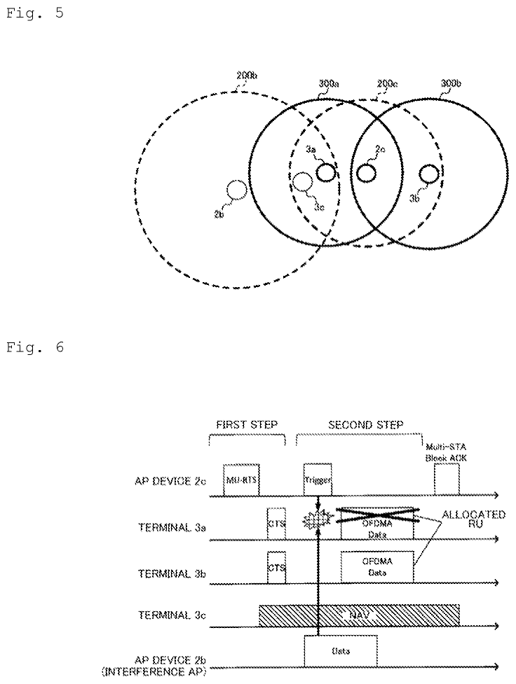

First, the operation of the wireless LAN system of the comparative example will be described with reference to FIGS. 5 and 6. FIG. 5 is a diagram schematically illustrating coverages of radio waves in the wireless LAN system of the comparative example. As shown in FIG. 5, the wireless LAN system of the comparative example includes, for example, access point devices (AP devices) 2c and 2b, and terminals 3a, 3b, and 3c, and performs multi-user transmission with MU-MIMO and OFDMA, conforming to the IEEE802.11ax.

The access point device 2c of the comparative example emits radio waves such as MU-RTS of a predetermined level within a coverage 200c. The access point device 2b emits radio waves such as MU-RTS of a predetermined level within a coverage 200b.

The terminals 3a, 3b, and 3c belong to the access point device 2c. Here, the terminal 3a is assumed to be a terminal (protected terminal) that is to be protected and has to satisfy predetermined conditions such as low latency, low jitter, and reduced packet loss. However, the terminal 3a may compete with the terminals 3b and 3c, which belong to a BSS with the access point device 2c set as an AP (access point), in terms of wireless access.

In addition to the BSS with the access point device 2c set as an AP, there is also an OBSS with the access point device 2b set as an AP. It is assumed that the terminals 3a and 3c are also able to recognize traffic from the access point device 2b.

Note that the terminal 3a emits radio waves such as CTS of a predetermined level within a coverage 300a. The terminal 3b emits radio waves such as CTS of a predetermined level within a coverage 300b.

FIG. 6 is a timing chart illustrating an example of a timing of data transmission (uplink) in the wireless LAN system of the comparative example. For example, when performing uplink or downlink OFDMA transmission, the access point device 2 determines whether or not to use an MU-RTS/CTS procedure (MU-RTS/CTS proceeding). In the following, a description of a case where the wireless LAN system of the comparative example executes an MU-RTS/CTS procedure will be given.

When performing data transmission using an MU-RTS/CTS procedure, the wireless LAN system of the comparative example performs two-stage control of designating terminals to be subjected to MU-RTS as a “first step”, and designating terminals to which actual data transmission resources are to be allocated as a “second step”.

The wireless LAN system of the comparative example designates the same terminal group in the “first step” and the “second step”, taking into consideration the intension that the specification of 802.11ax is standardized, and a control method envisioned to be typically implemented.

Also, the wireless LAN system of the comparative example performs an MU-RTS/CTS procedure on the terminals to which data is to be actually transmitted, thereby suppressing interference in the surroundings of the access point device 2 and the terminals 3 that are involved in transmission and reception.

In the wireless LAN system of the comparative example, the terminals 3a, 3b, and 3c belong to the access point device 2c, as shown in FIG. 5. In the data transmission (uplink) shown in FIG. 6, the access point device 2c selects terminals to which the opportunity of uplink communication is preferably to be given, with reference to Buffer Status Reports transmitted by the terminals 3, for example.

Here, the access point device 2c selects the terminals 3a and 3b for example, as the terminals to which the communication opportunity is preferably to be given. Then, the access point device 2c transmits an MU-RTS frame in which the selected terminals 3a and 3b are designated.

That is to say, the access point device 2c transmits an MU-RTS frame in which information (such as addresses) designating the terminals 3a and 3b, and bandwidths to be used in transmission of CTS by the respective terminals 3a and 3b are described in User Info fields.

The terminals 3a and 3b that have received the MU-RTS wait for SIFS (Short Inter Frame Space) time defined by the standard, and then transmit CTS to the access point device 2c. At this time, the terminal 3c that has received the MU-RTS sets waiting for transmission (NAV) in accordance with the received MU-RTS, because the address of the terminal 3c is not described in the User Info fields of the MU-RTS.

After receiving the CTS from the terminals 3a and 3b, the access point device 2c transmits a trigger frame. As described above, in the User Info fields of the trigger frame, the addresses of the terminals 3 to which the resources are to be allocated, and RUs to be allocated to the terminals 3 are described. Here, the access point device 2c describes, in the trigger frame, RUs to be allocated to the terminals 3a and 3b.

The terminals 3a and 3b that have received the trigger frame start data transmission (uplink) to the access point device 2c using the allocated RUs. The access point device 2c that has received data from the terminals 3a and 3b gives a notification of completion of the data transmission by transmitting a Block Ack frame.

That is to say, the access point device 2c designates the same terminal group for the MU-RTS (terminal group to be set as being protected in the MU-RTS/CTS) in the “first step”, as the terminal group to which the resources for transmitting data are to be allocated (terminal group to which RUs of OFDMA are to be allocated) in the “second step”.

At this time, as shown in FIG. 6 for example, a NAV based on the CTS from the terminal 3a is not set for the access point device 2b (and another terminal), which is (are) located out of the coverage 300a of radio waves (CTS) emitted from the terminal 3a.

On the other hand, the access point device 2b can transmit data to the terminal 3a due to the reason that the access point device 2b has transmission power larger than that of the terminal 3a, and the like. That is to say, as shown in FIG. 6, if the access point device 2b transmits data, the data will collide with the trigger frame that is transmitted by the access point device 2c, and thus the terminal 3a cannot transmit frames with OFDMA, and the transmission will result in an error.

Due to such a transmission error, the wireless LAN system of the comparative example may cause a reduction in the efficiency of use of resources, an increase in a delay, and an increase in jitter. That is to say, the wireless LAN system of the comparative example may have a problem in the communication quality in a high-density environment in which there is OBSS, for example.

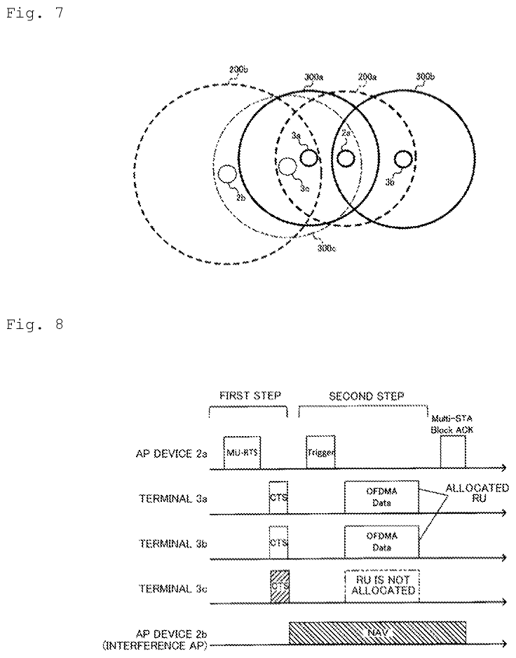

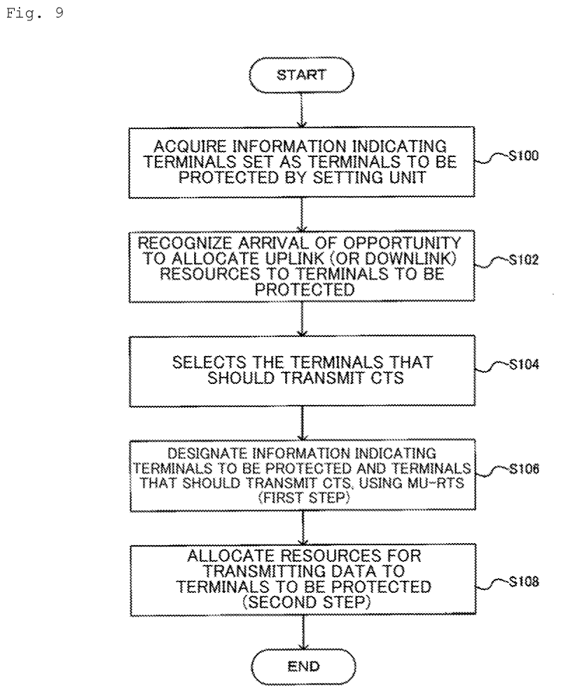

The following will describe the operation of the wireless LAN system 1 according to the embodiment with reference to FIGS. 7 and 8. FIG. 7 is a diagram schematically illustrating coverages of radio waves in the wireless LAN system 1 according to the embodiment. As shown in FIG. 7, the wireless LAN system 1 includes, for example, the access point devices (AP devices) 2a and 2b, and the terminals 3a, 3b, and 3c, and performs multi-user transmission with MU-MIMO and OFDMA, conforming to the IEEE802.11ax.

The access point device 2a emits radio waves such as MU-RTS of a predetermined level within a coverage 200a. The access point device 2b emits radio waves such as MU-RTS of a predetermined level within a coverage 200b.

The terminals 3a, 3b, and 3c belong to the access point device 2a. Here, it is assumed that the terminal 3a is a terminal (protected terminal) that is to be protected and has to satisfy predetermined conditions such as low latency, low jitter, and reduced packet loss. However, the terminal 3a may compete with the terminals 3b and 3c, which belong to a BSS with the access point device 2a set as an AP (access point), in terms of wireless access.

In addition to the BSS with the access point device 2a set as an AP, there is also an OBSS with the access point device 2b set as an AP. It is assumed that the terminals 3a and 3c are also able to recognize traffic from the access point device 2b.

Note that the terminal 3a emits radio waves such as CTS of a predetermined level within a coverage 300a. The terminal 3b emits radio waves such as CTS of a predetermined level within a coverage 300b. The terminal 3c emits radio waves such as CTS of a predetermined level within a coverage 300c. Also, the access point devices 2a and 2b, and the terminal 3a are located within the coverage 300c of the terminal 3c.

FIG. 8 is a timing chart illustrating an example of a timing of data transmission (uplink) in the wireless LAN system 1 according to the embodiment. When performing data transmission using an MU-RTS/CTS procedure, the wireless LAN system 1 performs two-stage control of designating terminals to be subjected to MU-RTS/CTS as a “first step”, and designating terminals to which actual data transmission resources are to be allocated as a “second step”.

At this time, the wireless LAN system 1 is configured to be able to designate different terminal groups between in the “first step” and in the “second step”.

Specifically, in the wireless LAN system 1, the terminals 3a, 3b, and 3c belong to the access point device 2a, as shown in FIG. 7. In the data transmission (uplink) shown in FIG. 8, the access point device 2a selects terminals to which the opportunity of uplink communication is preferably to be given, and the like, with reference to Buffer Status Reports transmitted by the terminals 3, for example.

Here, the access point device 2a selects the terminals 3a, 3b, and 3c for example. Then, the access point device 2a transmits an MU-RTS frame in which the selected terminals 3a, 3b, and 3c are designated.

That is to say, the access point device 2a transmits an MU-RTS frame in which information (such as addresses) designating the terminals 3a, 3b, and 3c, and bandwidths to be used in transmission of CTS by the respective terminals 3a, 3b, and 3c are described in User Info fields.

The terminals 3a, 3b, and 3c that have received the MU-RTS wait for SIFS time defined by the standard, and then transmit CTS to the access point device 2a.

After receiving the CTS from the terminals 3a, 3b, and 3c, the access point device 2a transmits a trigger frame. As described above, in the User Info fields of the trigger frame, the addresses of the terminals 3 to which the resources are to be allocated, and RUs to be allocated to the terminals 3 are described. Here, the access point device 2a describes, in the trigger frame, RUs to be allocated to the terminals 3a and 3b. That is to say, the access point device 2a does not allocate a RU to the terminal 3c.

The terminals 3a and 3b that have received the trigger frame start data transmission (uplink) to the access point device 2a using the allocated RUs. The access point device 2a that has received data from the terminals 3a and 3b gives a notification of completion of the data transmission by transmitting a Block Ack frame.

That is to say, the access point device 2a designates a terminal group for the MU-RTS (terminal group to be set as being protected in the MU-RTS/CTS) in the “first step”, different from the terminal group to which the resources for transmitting data are to be allocated (terminal group to which RUs of OFDMA are to be allocated) in the “second step”.

At this time, as shown in FIG. 8, a NAV based on the CTS from the terminal 3a is not set for the access point device 2b (and another terminal), which is (are) located out of the coverage 300a of radio waves (CTS) emitted from the terminal 3a. However, a NAV based on the CTS transmitted from the terminal 3c is set for the access point device 2b (and another terminal).

Accordingly, although the access point device 2b has transmission power larger than that of the terminal 3a, the access point device 2b does not transmit data to the terminal 3a, since the CTS is transmitted in a broader area. That is to say, as shown in FIG. 8, since the access point device 2b does not transmits data, the terminals 3a and 3b can reliably transmit frames with OFDMA, in accordance with the trigger frame that is transmitted by the access point device 2a.

FIG. 9 is a flowchart illustrating an example of an operation of the access point device 2a according to the embodiment. As shown in FIG. 9, the control unit 21 of the access point device 2a acquires information indicating the terminal that is set as a terminal to be protected by the setting unit 20 (S100).

If the control unit 21 recognizes the arrival of an opportunity to allocate uplink (or downlink) resources to the terminal to be protected (S102), the selection unit 210 selects terminals that should transmit CTS (S104).

Then, the access point device 2a designates, using MU-RTS, information indicating the terminal to be protected and the terminals that should transmit CTS (S106).

Also, the access point device 2a allocates resources for transmitting data to the terminal to be protected (S108).

In this way, in the wireless LAN system 1, if the access point device 2a allocates resources to the terminal 3a, which is a protected terminal, and the terminal 3b, the access point device 2a designates not only the terminals 3a and 3b but also the terminal 3c in the “first step” (selection step). Then, in the “second step”, the access point device 2a designates only the terminals 3a and 3b to which RUs are to be allocated, and does not designate the terminal 3c (allocation step). Thus, in the wireless LAN system 1, CTS can be efficiently transmitted, and interference can be reduced.

Specifically, even if the terminal 3a is located within the coverage 200c of the access point device 2b, the communication opportunity of the terminal 3a is protected by CTS transmitted by the terminal 3c, which does not transmit data, and thus the terminal 3a can satisfy predetermined conditions such as low latency, low jitter, and reduced packet loss. That is to say, the wireless LAN system 1 can improve the communication quality even in a high-density environment in which there is an OBSS, for example.

Note that if the wireless LAN system 1 is in the state shown in FIG. 7, and only the terminal 3b is a protected terminal, the access point device 2b does not need to cause the terminal 3c to transmit CTS because the access point device 2b does not affect the terminal 3b thus.

In this case, the determination unit 212 of the access point device 2a may determine whether or not to cause the terminal 3c to transmit CTS, based on the positional relationship between the terminals 3a, 3b, and 3c, and the access point device 2b, the radio wave strength, and the like.

Also, the access point device 2a may instruct the terminals 3a, 3b, and 3c to give a notification of the number of surrounding APs that use the same channel or the amount of use of the channel by the OBSS, and the like that is obtained from scan information of the APs. Also, the determination unit 212 of the access point device 2a may determine whether or not the terminals 3a, 3b, and 3c are each a terminal that is highly likely to effectively function as a terminal that transmits CTS, based on the given information.

Also, the wireless LAN system 1 may also include a controller that controls each of the plurality of access point devices 2, and the controller may be configured to collect received power information of the plurality of access point devices 2 and the plurality of terminals 3 from the access point devices 2. In this case, the controller may indicate the received power information and the positional relationship in a graph for example, and may determine the effectiveness in transmission of CTS for each of the terminals 3.

Note that the operation of the above-described wireless LAN system 1 has been described taking the uplink OFDMA transmission as an example, but the same control is applicable to the downlink OFDMA transmission.

For example, if the wireless LAN system 1 performs downlink transmission, in the operation of the “second step”, RU allocation (designation) to a terminal group is performed using the preamble of an OFDMA data frame, instead of RU allocation being performed using a trigger frame.

That is to say, the wireless LAN system 1 uses both an MU-RTS frame and a trigger frame in uplink, and uses only an MU-RTS frame in downlink, without using a trigger frame.

Note that the above-described embodiment exemplary describe an embodiment of the present invention, but not in a restrictive manner, and the present invention can be implemented also in other various modified aspects and changed aspects.

### REFERENCE SIGNS LIST

1 Wireless LAN system
2a, 2b, 2c Access point device
3a, 3b, 3c Terminal
20 Setting unit
21, 31 Control unit
22, 32 Frame generation unit
23, 33 Communication unit
24, 34 Antenna
25, 35 Communication I/F unit
210 Selection unit
212 Determination unit
214 Allocation unit
230, 330 Signal transmitting/receiving unit
232, 332 RF unit
200a, 200b, 200c, 300a, 300b, 300c Coverage

1. A wireless LAN system that performs multi-user transmission using OFDMA between a plurality of terminals and at least one access point device,
wherein the access point device includes:
a selection unit configured to select, as terminals to be caused to transmit CTS in response to an MU-RTS frame, terminals that satisfy predetermined conditions and include at least a terminal that is to be protected and has to satisfy predetermined low latency and low jitter, regardless of whether or not the terminals are terminals to which a resource for transmitting data should be allocated;
an allocation unit configured to allocate the resource for transmitting data to the terminals;
a frame generation unit configured to generate the MU-RTS frame such that the terminals selected by the selection unit transmit the CTS, and generates a frame that contains a signal indicating the resource allocated by the allocation unit; and
a communication unit configured to transmit the frames generated by the frame generation unit to the plurality of terminals, and
the selection unit selects terminals the number of which is greater than or equal to the number of terminals to which the resource is allocated by the allocation unit.

2. The wireless LAN system according to claim 1,
wherein the selection unit selects, as terminals that satisfy one of the predetermined conditions, terminals specified in advance, terminals randomly specified from a plurality of terminals belonging to the access point device, terminals specified in the ascending order in the level of RSSI of the access point device, or terminals specified in the descending order in the amount of interference from an OBSS.

3. The wireless LAN system according to claim 1,
wherein the access point device further includes
a determination unit configured to determine whether or not each of the terminals is a terminal that should be caused to transmit the CTS, and
the selection unit does not select a terminal that has not been determined as the terminal that should be caused to transmit the CTS by the determination unit, regardless of whether or not the terminal satisfies the predetermined conditions.

4. An access point device that performs multi-user transmission using OFDMA to a plurality of terminals, the access point device comprising:
a selection unit configured to select, as terminals to be caused to transmit CTS in response to an MU-RTS frame, terminals that satisfy predetermined conditions and include at least a terminal that is to be protected and has to satisfy predetermined low latency and low jitter, regardless of whether or not the terminals are terminals to which a resource for transmitting data should be allocated;
an allocation unit configured to allocate the resource for transmitting data to the terminals;
a frame generation unit configured to generate the MU-RTS frame such that the terminals selected by the selection unit transmit the CTS, and generates a frame that contains a signal indicating the resource allocated by the allocation unit; and
a communication unit configured to transmit the frames generated by the frame generation unit to the plurality of terminals,
wherein the selection unit selects terminals the number of which is greater than or equal to the number of terminals to which the resource is allocated by the allocation unit.

5. The access point device according to claim 4,
wherein the selection unit selects, as terminals that satisfy one of the predetermined conditions, terminals specified in advance, terminals randomly specified from a plurality of terminals belonging to the access point device, terminals specified in the ascending order in the level of RSSI of the access point device, or terminals specified in the descending order in the amount of interference from an OBSS.

6. The access point device according to claim 4, further comprising
a determination unit configured to determine whether or not each of the terminals is a terminal that should be caused to transmit CTS,
wherein the selection unit does not select a terminal that has not been determined as the terminal that should be caused to transmit CTS by the determination unit, regardless of whether or not the terminal satisfies the predetermined conditions.

7. A wireless communication method for performing multi-user transmission using OFDMA between a plurality of terminals and at least one access point device, the method comprising:
a selection step of selecting, as terminals to be caused to transmit CTS in response to an MU-RTS frame, as terminals to be caused to transmit CTS in response to an MU-RTS frame, terminals that satisfy predetermined conditions and include at least a terminal that is to be protected and has to satisfy predetermined low latency and low jitter, regardless of whether or not the terminals are terminals to which a resource for transmitting data should be allocated;
an allocation step of allocating the resource for transmitting data to the terminals;
a frame generation step of generating the MU-RTS frame such that the selected terminals transmit the CTS, and generates a frame that contains a signal indicating the allocated resource; and
a communication step of transmitting the generated frames to the plurality of terminals,
wherein in the selection step, terminals the number of which is greater than or equal to the number of terminals to which the resource is allocated in the allocation step are selected.

8. The wireless communication method according to claim 7,
wherein in the selection step, as terminals that satisfy one of the predetermined conditions, terminals specified in advance, terminals randomly specified from a plurality of terminals belonging to the access point device, terminals specified in the ascending order in the level of RSSI of the access point device, or terminals specified in the descending order in the amount of interference from an OBSS are selected.

9. The wireless communication method according to claim 7, further comprising
a determination step of determining whether or not each of the terminals is a terminal that should be caused to transmit the CTS,
wherein in the selection step, a terminal that has not been determined as the terminal should be caused to transmit the CTS in the determination step is not selected, regardless of whether or not the terminal satisfies the predetermined conditions.
